(19) United States
(12) Patent Application Publication
(10) Pub. No.: US 2023/0081789 A1
(43) Pub. Date: Mar. 16, 2023

(54) TWO-STEP VALVE CLOSING ROCKER ASSEMBLY

(71) Applicant: Jacobs Vehicle Systems, Inc., Bloomfield, CT (US)

(72) Inventors: John A. SCHWOERER, Storrs Mansfield, CT (US); Gabriel S. ROBERTS, Wallingford, CT (US); John MANDELL, Vernon, CT (US); G. Michael GRON, Jr., Granby, CT (US); Justin D. BALTRUCKI, Canton, CT (US); Trevor MORRISSEY, Chesire, CT (US)

(21) Appl. No.: 17/930,951

(22) Filed: Sep. 9, 2022

Related U.S. Application Data
(60) Provisional application No. 63/261,084, filed on Sep. 10, 2021.

(51) Int. Cl. F01L 9/10; F01L 9/40; F01L 13/00; F01L 1/18

(52) U.S. Cl. CPC F01L 9/10; F01L 1/181; F01L 9/40; F01L 13/0005; F01L 2009/4088; F01L 2309/00

(57) ABSTRACT

A valve actuation system includes a rocker for conveying motion to an engine valve, a motion source arranged to impart motion to the rocker, rocker stop assembly configured to operate in an activated mode, in which the rocker stop assembly maintains the rocker in a position corresponding to partial valve lift, and a deactivated mode, in which the rocker stop assembly allows the rocker to move to a position corresponding to a fully closed valve position, and a rocker stop reset assembly for resetting the rocker stop assembly to the deactivated mode subsequent to a main event peak lift to thereby achieve late valve closing. A damper assembly may interact with the rocker stop assembly to provide a smooth transition of the rocker and valve motion to a late intake valve closing dwell. A valve catch assembly may control the seating velocity of the at least one valve.

### BACKGROUND

### Technical Field

The disclosure relates to internal combustion engine valve actuation systems, including systems that provide late intake valve closing (LIVC). The disclosure also relates to valve closing timing systems and valve catch systems. The disclosure further relates to methods associated with such systems.

Engine valve actuation systems that provide LIVC in internal combustion engines are known to provide improved fuel economy and lower operating costs by changing the effective compression ratio of the engine based on the operating conditions. LIVC has been shown to slightly improve fuel economy in certain operating conditions.

Such systems may also be advantageous by providing thermal management in the engine aftertreatment system by changing the effective compression ratio of the engine based on different operating conditions. LIVC has been shown to increase temperature based on operating conditions.

### Background Art

There are lost motion LIVC systems that use a collapsing lost motion piston in a rocker arm. However, one limitation with such systems is that the peak main event intake valve lift needs to be modified and this can impact performance in either operating condition (LIVC enabled vs. LIVC not enabled). Thus, it would be advantageous to provide a lost motion LIVC system that does not require modification of peak intake valve main event lift.

Many known variable valve actuation (VVA) systems are designed to achieve LIVC Miller cycle. For example, lost motion VVA systems are known in which a single motion source (VVA cam profile) is configured for LIVC. In this case, the single motion source must add lift to the closing portion of the normal cam profile to achieve LIVC and cancel (or lose) this LIVC lift to provide normal closing timing (i.e., closing without LIVC operation). Examples of such systems may be found in U.S. Pat. No. 6,883,492 (master-slave piston arrangement in an overhead housing), U.S. Pat. No. 7,484,483 (master-slave piston arrangement in a tappet between rocker and valve bridge), U.S. Pat. No. 5,829,397 (master-slave piston arrangement in a tappet between push-tube and rocker), U.S. Pat. No. 7,905,208 (collapsing valve bridge), and U.S. Pat. No. 6,510,824 (collapsing rocker pivot). However, such systems may have disadvantages for performance and cold start. Furthermore, the costs and complexity of such systems often make their use infeasible or prohibitive. Thus, it would be advantageous to provide an LIVC system that is less expensive and less complex than prior art VVA systems.

Some stationary power systems use a fixed Miller cycle because such systems spend a high percentage of time in a specific operating condition where Miller timing is desired. However, such systems suffer performance impacts in certain operating conditions because they do not have the ability to switch between LIVC and normal closing timing.

U.S. Pat. Application Publication No. 20030213443 (FIG. 1) discloses a system having a separate overhead housing designed to hold an intake rocker in an open position, thereby achieving LIVC Miller cycle. However, the use of an electronically controlled high-speed solenoid valve disclosed therein makes this system expensive, and a software or high-speed solenoid valve failure could lead to valve-piston contact and engine damage. Thus, an LIVC solution based on a mechanical reset system will enhance reliability, reduce risk of valve-piston contact, and reduce cost.

U.S. Pat. No. 7,156,062 (FIG. 2) describes a system having an intermediate lost motion actuator and self-adjusting valve catch (SAVC) that acts on a valve train element (e.g., a rocker arm) independently of a lost-motion system. U.S. Pat. No. 8,453,613 (FIG. 3) describes a system having an improved SAVC acting on a valve train element independently of a lost-motion system.

### SUMMARY

The instant disclosure describes valve actuation system embodiments that may include an LIVC system that overcomes many, if not all, of the above-noted shortcomings of prior art systems. With a lost motion LIVC system, as noted above, the peak main event lift is often modified. With an auxiliary rocker based LIVC system (e.g., U.S. Pat. No. 7,392,772 and U.S. Pat. 11,131,222) a separate cam lobe is required and there is a handoff that needs to be managed between the main event and the auxiliary LIVC event. One advantage of embodiments described in the instant disclosure is that all lift associated with intake valve motion, including LIVC capabilities, may be derived from a single cam lobe. Thus, the need for separate cam lobes and handoffs of the prior art is eliminated.

To achieve LIVC, the embodiments of the instant disclosure may provide valve actuation systems that utilize a rocker stop to hold the position of the intake rocker arm and valve open subsequent to peak main event lift (typically between typically 3 mm and full valve lift) to achieve a later closing event. The instant disclosure also describes different systems and methods used to achieve a pre-determined closing crank angle timing for the intake valve, such as a hydraulic reset. Furthermore, different systems and methods to control seating velocity by using a valve catch or a sub-base circle cam closing ramp are disclosed herein.

The rocker stop in disclosed embodiments is a hydraulic actuator piston that holds the rocker and valve open for a specified period of crank angle degrees before occurrence of a closing event. In an embodiment, the rocker stop actuator piston may be located in the rocker arm and may be arranged to cooperate with a damper assembly deployed in a stationary part of the overhead, e.g., the rocker shaft pedestal. Use of the damper ensures a smooth transition into the LIVC dwell. In alternative embodiments, the rocker motion stop actuator piston may be located in a stationary housing such that it contacts the valve or cam side of the rocker arm.

The rocker arm, and therefore valve closing timing can then be controlled based on a separate system. For example, as noted above and in accordance with prior art teachings, this can be done using an electronically controlled high-speed solenoid valve. However, in accordance with the instant disclosure, a crank-angle-based reset mechanism may provide a pre-determined intake valve closing timing by releasing hydraulic fluid from a high-pressure volume that otherwise maintains the actuator piston in a fixed, extended position (thereby holding the rocker arm/valve in the open position).

In various embodiments, the reset is triggered by the relative position of the cam to the rocker arm. As the rocker stop actuator piston holds the rocker stationary, the cam is still moving away from the rocker as the cam approaches a normal closing position. A reset mechanism between the rocker and cam (or pushrod connected to cam) can be used to time a reset of the actuator piston relative to crank angle degrees such that the rocker arm and valve are permitted to fully close.

In one embodiment, valve seating velocity—once the motion stop actuator piston has been reset—is controlled by a valve catch (similar in construction to the damper). The valve catch may be activated only in LIVC mode by selectively switching an oil supply to the valve catch. In this embodiment, the valve catch, may be disposed in a stationary part of the engine overhead environment and configured to engage with the rocker arm to control impact load and valvetrain dynamics. In another embodiment, a sub-base cam profile is provided with a closing ramp, where the reset mechanism permits the actuator piston to collapse at a rate such that the rocker arm follows the sub-based closing ramp.

According to an aspect of the disclosure, a valve actuation system for actuating at least one engine valve may comprise: a rocker for conveying motion to the at least one valve; a motion source arranged to impart motion to the rocker, the motion source defining a main event peak lift for the at least one engine valve; a rocker stop assembly configured to operate in an activated mode, in which the rocker stop assembly maintains the rocker in a position corresponding to partial valve lift, and a deactivated mode, in which the rocker stop assembly allows the rocker to move to a position corresponding to a fully closed valve position; and a rocker stop reset assembly for resetting the rocker stop assembly to the deactivated mode subsequent to the main event peak lift to thereby achieve late valve closing.

According to further aspects of the disclosure, the rocker stop assembly may be disposed in the rocker or elsewhere in the valvetrain. The rocker stop assembly may be disposed in a cam side of the rocker. The rocker stop assembly may comprise a hydraulically actuated piston.

According to further aspects, the rocker stop reset assembly may be adapted to reset the rocker stop assembly to the deactivated mode at a predetermined rotational angle of an engine crankshaft or cam. The rocker stop reset assembly may comprise a plunger adapted to extend to take up lash between the motion source and rocker, wherein the plunger is further adapted to reset the rocker stop assembly to the deactivated mode when the plunger extends to a reset position. The rocker stop reset assembly may be adapted to retain the rocker stop assembly in the activated mode during a portion of a closing profile of the motion source. According to further aspects, the motion source may be a single cam lobe.

According to further aspects, the valve actuation system may comprise a damper assembly arranged to interact with the rocker stop assembly and adapted to provide a smooth transition of the rocker and valve motion to a late intake valve closing dwell. The damper assembly may be disposed in a fixed housing relative to the rocker.

According to further aspects, the rocker stop assembly and rocker stop reset assembly may be disposed on the cam side of the rocker. The rocker stop assembly and rocker stop reset assembly may be linked through at least one hydraulic passage.

According to further aspects, the motion source may comprise a sub-base circle cam profile with a closing ramp, where the rocker stop reset mechanism is adapted to permit the rocker stop assembly to collapse at a rate such that the rocker arm follows the sub-base circle closing ramp. The rocker stop reset mechanism may be adapted to reset the rocker stop assembly to the deactivated mode based on motion source lift and to collapse at a rate independent of the motion source. The rocker stop reset mechanism may comprise a spring-biased reset piston adapted to retain hydraulic fluid in the rocker stop assembly in the activated mode and to vent hydraulic fluid from the rocker stop assembly to ambient in the deactivated mode, wherein the reset piston is adapted to stay open during rocker stop assembly collapse.

Other aspects and advantages of the disclosure will be apparent to those of ordinary skill from the detailed description that follows and the above aspects should not be viewed as exhaustive or limiting. The foregoing general description and the following detailed description are intended to provide examples of the inventive aspects of this disclosure and should in no way be construed as limiting or restrictive of the scope defined in the appended claims.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 illustrates a prior art valve actuation system such as that described in the aforementioned U.S. Pat. Application Publication No. 20030213443;

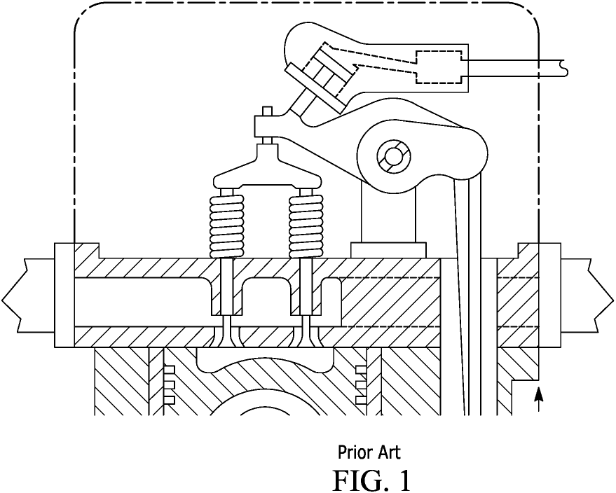

FIG. 2 illustrates a prior art valve actuation system such as that described in the aforementioned U.S. Pat. No. 7,156,062;

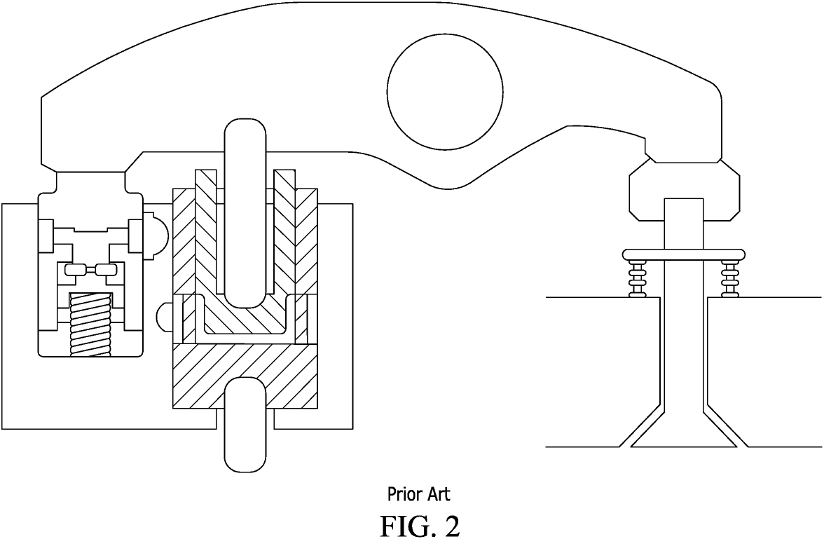

FIG. 3 illustrates a prior art valve actuation system such as that described in the aforementioned U.S. Pat. No. 8,453,613;

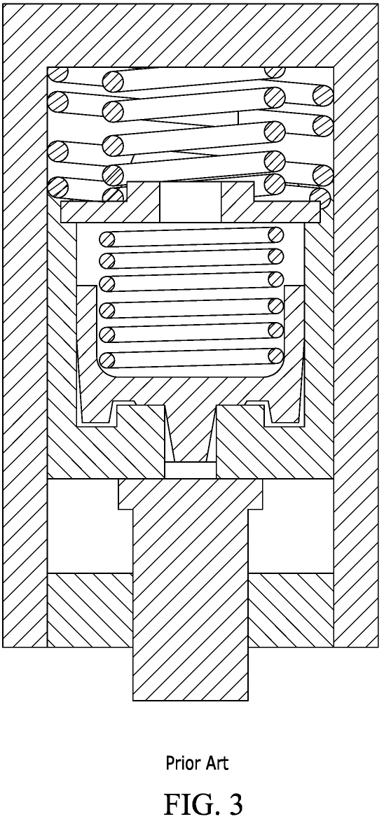

FIG. 4 is a schematic diagram illustrating example high level components and subcomponents of a valve actuation system according to aspects of the instant disclosure;

FIG. 5 is side perspective of a valve actuation system according to aspects of the instant disclosure;

FIG. 6 is a top front perspective of a valve actuation system according to aspects of the instant disclosure;

FIG. 7 is a cross-section (in a plane that is orthogonal to the rocker arm pivot plane) of example a valve actuation system including a rocker stop assembly and rocker stop reset assembly disposed in a motion source side of a rocker arm, and a damper assembly disposed in a fixed housing, all according to aspects of the instant disclosure;

FIG. 8 is a cross-section (in a plane that is parallel to the rocker arm pivot plane) of a rocker arm and rocker stop reset assembly according to aspects of the disclosure;

FIG. 9 is a cross-section (in a plane that is parallel to the rocker arm pivot plane) of a rocker arm, rocker stop assembly and damper assembly disposed in a fixed housing, all according to aspects of the instant disclosure, the rocker arm being in a valve lift position;

FIG. 10 is a cross-section (in a plane that is parallel to the rocker arm pivot plane) of a rocker stop reset assembly when the rocker arm is in a valve lift position (such as that shown in FIG. 9), according to aspects of the disclosure;

FIG. 11 is a cross-section (in a plane that is parallel to the rocker arm pivot plane) of a rocker arm, rocker stop assembly and damper assembly disposed in a fixed housing, all according to aspects of the instant disclosure, the rocker arm being in a stopped, dampened position, the damper assembly being in a dampened transition mode;

FIG. 12 is a cross-section (in a plane that is parallel to the rocker arm pivot plane) of a rocker arm, rocker stop assembly and damper assembly disposed in a fixed housing, all according to aspects of the instant disclosure, the rocker arm being in a stopped position, the damper assembly being in a solid contact dwell position;

FIG. 13 is a cross-section of a rocker stop reset assembly in a reset mode, according to aspects of the disclosure;

FIG. 14 is a cross-section of the rocker stop assembly in which the actuator piston is fully retracted into the actuator bore;

FIG. 15 is an example graphic representation of a cam profile and normal and LIVC lift profiles as a function of crank angle achieved with a valve actuation system according to aspects of the disclosure;

FIG. 16 is a side perspective of a second example valve actuation system according to aspects of the disclosure;

FIG. 17 is a top, front perspective of the second example valve actuation system of FIG. 16;

FIG. 18 is a cross-section of a rocker stop reset assembly in a reset mode, according to aspects of the disclosure;

FIG. 19 is a cross-section (in a plane that is parallel to the rocker arm pivot plane) showing an example rocker stop assembly, damper assembly and valve catch with the rocker arm in a valve lift position according to aspects of the disclosure;

FIG. 20 is a cross-section of a rocker arm, rocker stop assembly and damper assembly disposed in a fixed housing, the rocker arm being in a stopped, dampened position, the damper assembly being in a dampened transition mode;

FIG. 21 is a cross-section of a rocker arm, rocker stop assembly and damper assembly disposed in a fixed housing, all according to aspects of the instant disclosure, the rocker arm being in a stopped position, the damper assembly being in a solid contact dwell position;

FIG. 22 is a cross-section of a rocker stop reset assembly in a reset mode, according to aspects of the disclosure;

FIG. 23 is a cross-section of a rocker arm in a valve catch mode according to aspects of the disclosure; and

FIG. 24 is an example graphic representation of a cam profile and normal and LIVC lift profiles as a function of crank angle achieved with a valve actuation system according to aspects of the disclosure.

### DETAILED DESCRIPTION

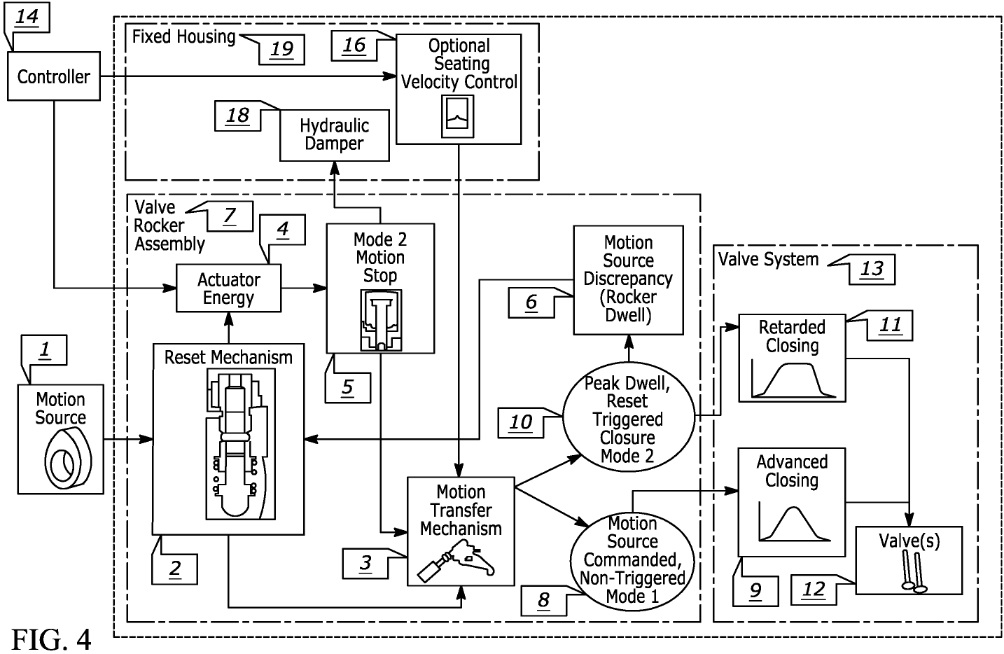

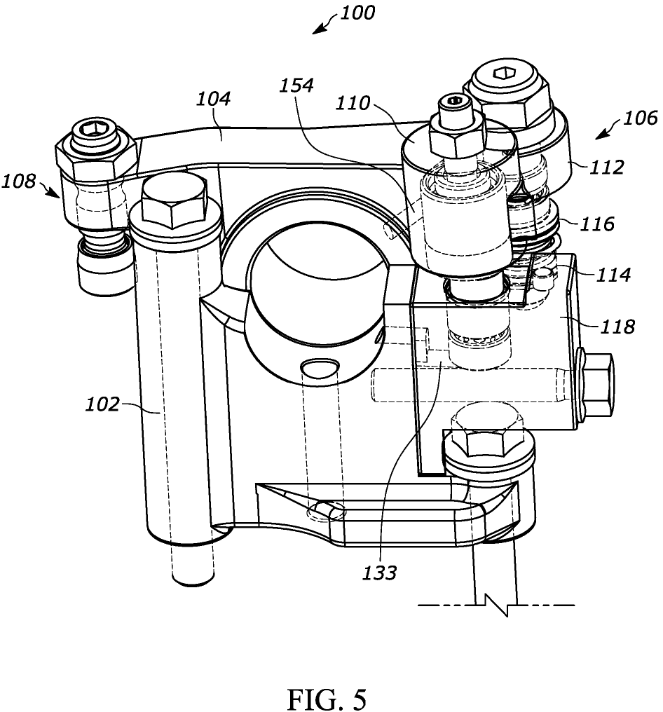

FIG. 4 is a schematic illustration of components of a valve actuation system in accordance with the instant disclosure. Specific implementation details of example systems according to this overview of FIG. 4 will become more apparent from the description that follows with reference to FIGS. 5-24. The high-level components and subcomponents of an example embodiment according to the disclosure may include a motion source (or cam) 1, a valve rocker assembly 7, a valve system 13, a controller 14 and a fixed housing 19. Example subcomponents of each of these high-level components are also illustrated, was well as their functional interactions and/or relationships. For example, the rocker valve assembly 7 may include a motion transfer mechanism or rocker arm 3, a rocker stop assembly 5 arranged and adapted to limit motion of the rocker arm 3, and a reset mechanism 2 adapted to reset the rocker stop assembly 5. For further example, fixed housing 19 may be a stationary structure (i.e., a rocker shaft pedestal which is stationary relative to the rocker arm motion) in the engine overhead environment and may support a hydraulic damper 18 and a valve catch 16 to control valve seating velocity, each of which may interact with the valve rocker assembly 7 to achieve LIVC and other valve motion. Specific implementations of these high-level components, subcomponents and their interactions in accordance with the instant disclosure will be further apparent from the illustrations in FIGS. 5-24 and the description which follows below.

Referring again to FIG. 4, a motion source 1, which may be a cam or a push tube driven by a cam, is arranged and adapted to generate motion to drive the rocker assembly 7. The motion transfer mechanism 3 (for example, a rocker arm) transfers motion from the cam 1 to the valves 12. In a preferred embodiment, the rocker arm 3 carries the reset mechanism 2 and the motion stop actuator 5, as described below. The whole valve rocker assembly is denoted by reference numeral 7. The cam 1 may contact a follower on the valve rocker assembly 7 directly or may operate in combination with a tappet or push tube to transmit motion to the rocker assembly 7. The valve rocker assembly 7 may include a reset mechanism 2 which is configured to maintain the rocker stop in a deployed state to achieve a valve lift dwell and to reset (collapse) the rocker stop at an appropriate crankshaft or cam rotational angle to achieve further (late) valve closure. In one embodiment, the rocker stop reset mechanism 2 may be disposed on a motion source cam side of the rocker arm 3 and positioned between the motion source 1 and the rocker arm 3. The reset mechanism 2 may have an internal spring arranged to bias the reset mechanism 2 against the motion source 1. This configuration permits the reset mechanism 2 to pick up any lash that is generated by a second mode retarded (late) closing 11 (described below).

A controller 14, such as a programmable engine control module (ECM) or the like, may provide for the control of actuator energy 4 by controlling hydraulic flow and pressure to the rocker stop assembly 5 to keep the rocker stop assembly 5 in a deployed (extended) state and thus create a motion source discrepancy 6 which causes the valve to dwell in a partially lifted state. The rocker stop reset mechanism 2 may operate as a check against flow of hydraulic fluid from the motion stop actuator 5 when pressurized by a controlled supply of hydraulic oil 4 as the valves 12 are opening. The rocker stop reset mechanism 2, when triggered to a reset mode, may interrupt, reset or purge the actuator energy (hydraulic fluid) 4 from the rocker stop mechanism 5 to achieve valve closing. The rocker stop reset mechanism 2 may be adapted and arranged to trigger at a specific crank angle on the closing portion of the cam profile. As will be detailed below, the rocker stop reset mechanism 2 may include a reset piston or plunger that follows the cam profile. When the reset piston extends more than a specific amount when following the closing portion of the cam profile, one or more reset ports on the reset piston will permit flow of hydraulic fluid from the rocker stop mechanism and result in collapse or reset of a rocker stop piston. This in turn permits the rocker to continue with a valve closing motion. In embodiments illustrated in further detail below, the reset mechanism 2 may include a lash adjustment on the cam side.

The motion stop 5 may be an actuator piston slidably disposed in the rocker assembly 7 and normally biased in the retracted position unless hydraulic energy/pressure 4 causes the actuator piston to extend. The actuator extends in concordance with the motion source 1 to the extent that the valves 12 are opened at peak lift. During operation, the oil is checked in the motion stop actuator 5 by the reset mechanism 2 and reacts against a hydraulic damper 18, keeping the motion transfer mechanism, in this case a rocker assembly 7, cocked open until the reset mechanism 2 causes the oil in the motion stop actuator 5 to purge completely.

As will be recognized, the operation of the rocker stop mechanism 5, when activated, creates a discrepancy 6 between the motion source 1 and the rocker arm 3. In other words, when the rocker stop mechanism 5 is activated, the rocker arm does not follow the closing profile of the motion source 1 but rather dwells in a position that corresponds to partial valve lift, thus implementing the desired LIVC operation. When the rocker arm 3 is propped towards the valves 12, thereby keeping the valves 12 open, and the cam 1 begins to rotate through its valve closing profile to command the rocker arm 3 and valves to a closed position, a gap/discrepancy 6 begins to form between the cam side of the rocker 3 and the cam 1 (or push tube or other valve train component). As a result of this gap, the reset piston in the reset mechanism 2 may begin to extend to compensate for the gap until a reset mode is reached, whereby the rocker arm and valve continue to a fully closed position, thus achieving LIVC.

Referring still to FIG. 4, the valve rocker assembly 7 causes the valve system 13 to operate in either a first (advanced or normal closing) mode 9 or second (late or retarded closing) mode 11. The normal closing mode 9 is characterized by the valve rocker assembly 7 and rocker arm 3 operating as commanded by the motion source 1 through the cam closing profile, the rocker stop 5 operating in a non-actuated, non-triggered mode 8. On the other hand, the late closing mode 11 is characterized by the valve rocker assembly 7 and rocker arm 3 operating as commanded by the cam 1, except that during the cam closing profile, the rocker stop 5 is activated to cause the valve to dwell in a partially lifted state, followed by a reset of the reset mechanism 2 to reset the rocker stop and achieve a delayed or late valve closing. Reference numeral 10 corresponds to the second mode where the valve system 13 is commanded by the rotational motion of the cam 1 during valve opening, but dwells in an opened state beyond what the cam (1) is actually commanding, thereby opening up a gap 6 between the rocker 3 and the cam 1 that is taken up by the reset mechanism 2. Reference numeral 11 represents the retarded valve closing profile of the second mode 10 that corresponds to the same valve opening profile as the first mode 9, but where the rocker arm 3 is propped open until released by the reset mechanism 2, resulting in an elongated closing profile (or dwell) that causes the valves 12 to close later than usual. This LIVC dwell may occur at peak cam lift or at a lower lift, typically at least 3 mm valve lift. As known in the art, one or more valves 12 may be further engaged by a valve bridge, and the poppet valves 12 set may be biased towards the closed position by a set of valve springs.

According to further aspects of the disclosure, the controller 14, via solenoid valve and a hydraulic link, may selectively activate a self-adjusting valve catch 16 in order to minimize seating velocity of the rocker arm during the second mode 10 retarded closing event 11. The valve catch 16 may be active in both the first and second modes 8 and 10, previously discussed. The self-adjusting valve catch may be disposed in a fixed housing 19 and may be arranged to cooperate with the rocker arm 3.

According to further aspects of the disclosure, the controller 14 may selectively activate, via control or solenoid valve and a hydraulic link, a hydraulic damper 18 that provides a smooth transition between the cam-driven closing profile and the LIVC dwell. The hydraulic damper may be disposed in the fixed housing 19 and cooperate with the rocker arm stop 5.

The details and interrelationships of the high level components and subcomponents described relative to FIG. 4 will become further apparent from the following description of particular examples and implementations in FIGS. 5-24.

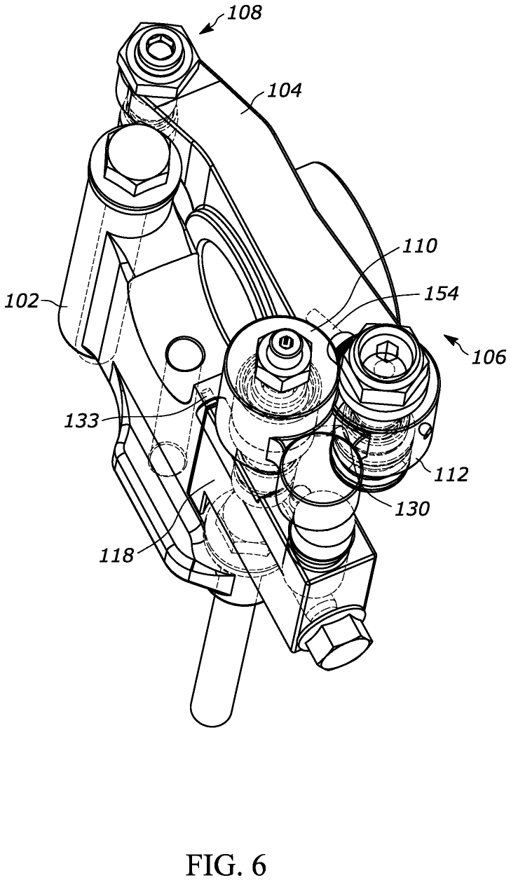

FIGS. 5 and 6 illustrate a first embodiment of a valve actuation system 100 comprising a rocker shaft pedestal 102 and a rocker arm 104 mounted on a rocker shaft for pivoting movement relative to the rocker shaft pedestal 102. For clarity, the rocker shaft is omitted from the illustrations in FIGS. 5 and 6 but, as will be recognized, the rocker shaft is typically secured to the rocker shaft pedestal 102 and extends through a journal of the rocker arm 104 to facilitate pivoting movement of the rocker arm 104 on the rocker shaft. The rocker arm 104 includes a cam (or motion source) side 106 and a valve side 108. In accordance with aspects of the disclosure, the motion source side 106 of the rocker arm 104 further includes and houses a rocker stop actuator assembly 110 and a rocker stop reset assembly 112, the details of which will be described below. A hydraulic passage 154 in the rocker arm 104 may provide a pressurized hydraulic fluid received from a port in the rocker shaft (which in turn receives oil from an upstream pump and oil reservoir as is known in the art) to the rocker stop reset assembly 112. A further passage 130 in the rocker arm 104 may provide a hydraulic link between the rocker stop reset assembly and the rocker stop actuator assembly 110. The rocker stop actuator assembly 110, when hydraulically or mechanically actuated, functions to selectively limit or stop pivoting movement of the rocker arm 104 (i.e., limiting movement in a clockwise direction as viewed in FIG. 5). Rocker stop actuator assembly 110 thus functions to stop the valve side 108 of the rocker arm 104 from reaching a position corresponding to valve full closure (i.e., thus holding the valve in a non-closed or partially lifted position for a time after peak lift to facilitate LIVC).

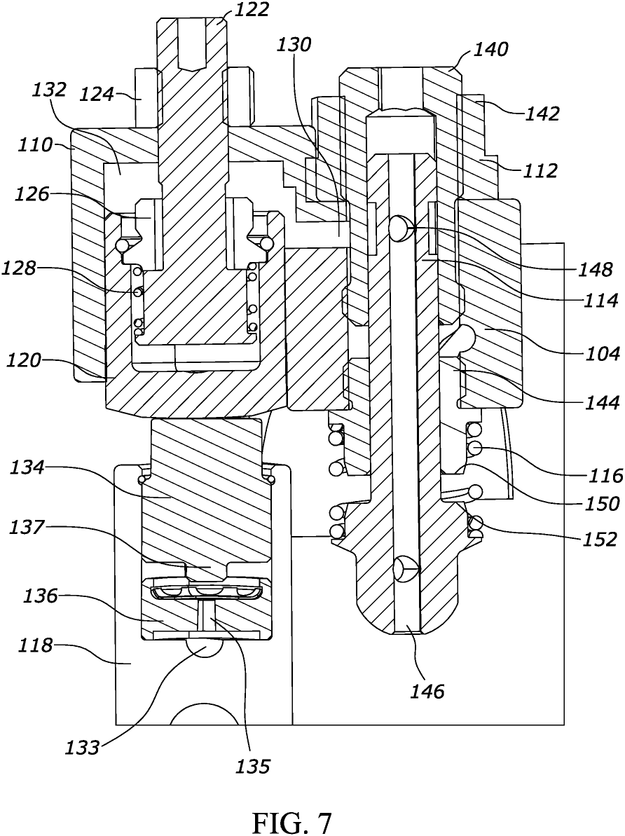

As also shown in FIGS. 5 and 6, and referring additionally to FIG. 7, according to aspects of the disclosure, the rocker stop reset assembly 112 may include a reset plunger 114, which may be biased towards a non-reset position (i.e., a maximum downward displacement relative to upper reset body 140) by a reset plunger spring 116. The reset plunger 114 extends towards the valve motion source (not shown). The reset plunger 114 may be operatively connected to a push tube which, in turn, is operatively associated with and actuated by the cam. The rocker stop reset assembly 112 is adapted and arranged to provide a reset of the rocker stop actuator assembly 110, for example, by venting hydraulic fluid from the rocker stop actuator assembly 110 at an appropriate crank or cam rotational angle to thus allow reset (retraction) of the rocker stop assembly piston 120 into the bore 132 with a resulting continued closing motion of the rocker arm and resulting closure of the valve in an LIVC operation.

According to further aspects of the disclosure, a damper assembly 118 may be housed within or extend from the rocker shaft pedestal and functions, at times, to control movement of the rocker stop actuator assembly 110, rocker arm 104, and thus motion of the valve end 108 and valve. As described in further detail below, the damper assembly 118 is adapted and arranged to interact with rocker stop actuator assembly 110 to provide smooth transitions in valve motion, such as transition between normal (i.e., main event) valve actuation motions and LIVC events. A further passage 133 may supply hydraulic fluid from the rocker shaft to the damper assembly 118.

Referring now to FIG. 7, further details of the rocker stop actuator assembly 110, rocker stop reset assembly 112 and damper assembly 118 are illustrated in cross-section taken through the motion source end 106 (FIG. 5) of the rocker arm 104. In particular, the rocker stop actuator assembly 110 may include an actuator piston 120 slidably disposed in an actuator bore 132 formed in the motion source side 106 of the rocker arm 104. A lash adjustment screw 122 and lash adjustment nut 124 are provided which, as known in the art, permit lash adjustment of the actuator piston 120. An actuator spring retainer 126 may be slidably disposed on the lash screw 122 and an actuator spring 128 is disposed between a shoulder on the lash screw 122 and the actuator spring retainer 126 such that, absent any hydraulic actuation (i.e., suitable hydraulic pressure in bore 132) of the actuator piston 120, the actuator piston 120 will be biased to retract into the actuator bore 132.

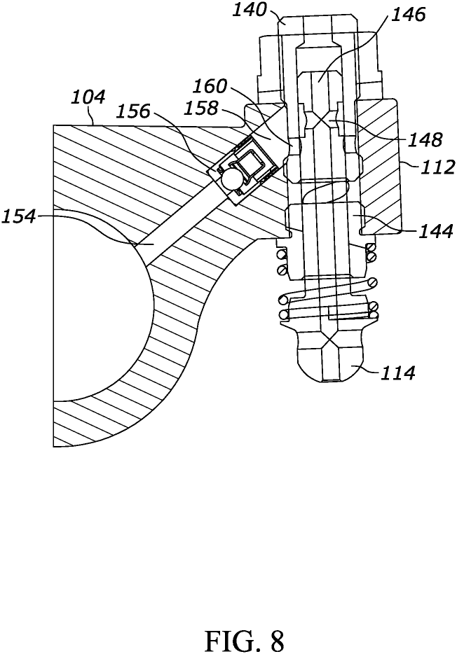

Actuation of the rocker stop actuator assembly 110 may be controlled via a hydraulic actuating circuit or links comprising various passages within components of the valvetrain, as will be detailed below. The hydraulic actuating circuit may include a first hydraulic passage 130 in hydraulic communication with the actuator bore 132. Although not shown in FIG. 7, the first hydraulic passage 130 is in fluid communication with second hydraulic passage 158 (FIG. 8) by way of an additional passage in the rocker arm (i.e., a fly cut area connecting passage 158 to passage 130) that may permit selective (for example, under control of a solenoid valve) supply of hydraulic fluid to the first hydraulic passage 130 and actuator bore 132 to actuate the rocker stop assembly. As will be recognized, such an additional passage may provide fluid communication from passage 158 to passage 130 and to the actuator bore 132 regardless of the state (reset mode or non-reset mode) of the rocker stop reset assembly

The rocker stop reset assembly 112 comprises an upper reset body 140 and a separate, lower reset body 144, both of which may be fastened to the rocker arm 104 with threaded fittings and both of which have internal bores that guide and permit sliding movement of the reset plunger 114. The upper reset body 140 may comprise a lash adjustment screw (and corresponding lash adjustment nut 142) that facilitate lash adjustment of the reset plunger 114. The lower reset body 144 is fixedly attached to (e.g., threaded engagement) the rocker arm 104 such that the reset plunger 114 extends out of the lower reset body 144 towards (i.e., downward in FIG. 7) a valve actuation motion source (e.g., push tube and cam, not shown). The reset plunger spring 116 is positioned between respective shoulders formed in the lower reset body 144 and formed in a lower portion of the reset plunger 114 such that the reset plunger 114 is biased into contact with the motion source (i.e., biased downward in FIG. 7). Upward travel of the reset plunger 114 (i.e., into the longitudinal channel formed in the upper reset body 140) is limited when solid contact between a lower reset body shoulder 150 and a reset plunger shoulder 152 occurs. As shown, the reset plunger 114 further comprises a venting passage 146 formed therein and configured to provide fluid communication with ambient atmosphere and an oil return path (i.e., dripping/flow into and through the overhead environment via appropriate passages to an oil pan) in the engine overhead environment. As described in further detail with respect to FIG. 8, a reset port 148 is provided as a radial opening (i.e., radially extending port) formed in the reset plunger 114 and in fluid communication with the venting passage 146.

FIG. 8 illustrates further details, in cross section, of the rocker stop reset assembly 112 and rocker arm 104. As shown, the rocker arm 104 includes a fourth hydraulic passage 154 configured to receive selectively applied hydraulic fluid from a rocker arm shaft (not shown) using known techniques. A check valve assembly 156 provides one-way fluid communication with the fourth hydraulic passage 154 and the second hydraulic passage 158. A spill port 160, formed in the upper reset body 140, provides selective (i.e., depending on the position of the lower reset body 144) hydraulic communication with the volume established by the actuator bore 132, first hydraulic passage 130 and second hydraulic passage 158.

As described in further detail below, in an extended mode of the rocker arm stop assembly 110, the reset plunger 114 may be in a lower position shown in FIG. 7 relative to the upper reset body 140 and an outer diameter of the reset plunger 114 may seal off the second hydraulic passage 158, thereby sealing off the volume established by the actuator bore 132, first hydraulic passage 130 and second hydraulic passage 158. During such operation, pressurized hydraulic fluid from the fourth hydraulic passage 154 will enter the actuator bore 132, overcome the bias applied by the actuator piston spring 128 thereby causing the actuator piston 120 to extend from the actuator bore 132.

According to aspects of the disclosure, the rocker stop reset assembly 140 facilitates a reset mode of the rocker arm stop assembly 110, as the reset plunger 114 translates (i.e., moves downward in FIG. 7) within the upper reset housing 140 (due to application of valve actuation motions thereto), the reset port 148 formed in the reset plunger 114 will periodically align with a spill port 160. During such operation, the hydraulic fluid trapped in the actuator bore 132 will be permitted to escape via the flow path established by the first hydraulic passage 130, second hydraulic passage 158, spill port 160, reset port 148 and venting passage 146, thereby permitting the actuator piston 120 to retract into the actuator bore 132 once again.

The damper assembly 118 comprises a damper piston 134 and base 136. A third hydraulic passage 133 is provided in the rocker shaft pedestal 102, which supplies hydraulic fluid through an opening 135 in the base 136 and into a space between the base 136 and the damper piston 134. As further shown, the damper piston 134 also includes a protrusion 137 aligned with and capable of sealing off the opening 135 when the protrusion 137 abuts the base 136. Provision of pressurized hydraulic fluid to the damper assembly 118 may be on a continuous basis or selectively switched through an appropriate control device (e.g., solenoid). When hydraulic fluid is present in the space between the damper piston 134 and base 136, downward pressure applied to the damper piston 134 by the actuator piston 120 will cause the hydraulic fluid to escape back through the opening 135 and into the third hydraulic passage 133. Continued downward translation of the damper piston 134 and protrusion 137 will progressively reduce the flow area between the protrusion and opening 135, thereby progressively slowing the flow the hydraulic fluid and, consequently, the rate of translation of the damper piston 134 until such time that the protrusion 137 abuts the base 136, thereby ceasing any further translation of the damper piston 134.

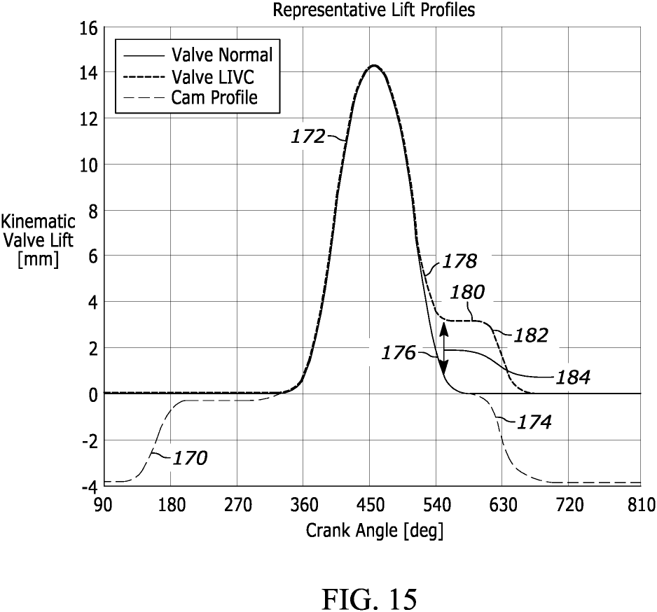

FIG. 15 illustrates an intake cam profile 170 suitable for use in conjunction with the embodiment illustrated in FIGS. 5-14. In particular, the cam profile 170 illustrates a main intake event 172 that, as known in the art, facilitates positive power generation in a fueled cylinder of an internal combustion engine. The cam profile 170 further comprises so-called sub-base circle features including a second closing ramp 174 employed during LIVC operation of the valve actuation system 100 of FIGS. 5-8. During normal main event 172 operation, hydraulic fluid is not provided to the actuator bore 132, thereby preventing extension of the actuator piston 120. Consequently, the actuator piston 120 will not engage the damper piston 134 such that the rocker arm is permitted to close according to a first closing ramp 176 in a normal manner, i.e., without LIVC operation. However, during LIVC operation, hydraulic fluid is provided to (and trapped within) the actuator bore 132 such that the actuator piston 120 will be maintained in its extended position, thereby maintaining the engine valve in an opened position 180 to provide the desired LIVC operation. Interaction of the actuator piston 120 and the damper piston 134 (FIG. 7) provides a smooth transition 178 between the main event lift 172 and LIVC dwell 180. As described in further detail below, subsequent operation of the rocker stop reset assembly 112 will cause the actuator piston 120 to collapse, thereby providing a closing event 182 commanded by the second closing ramp 174.

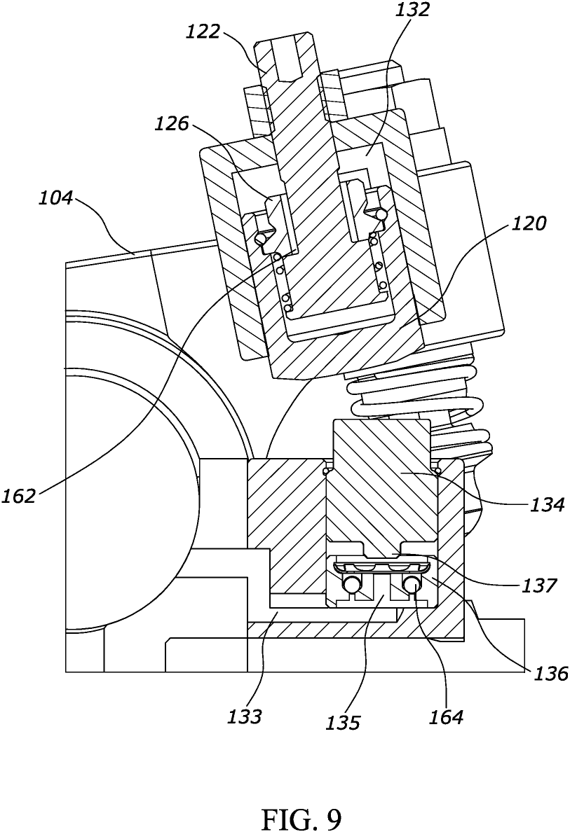

Further operation of the embodiment illustrated in FIGS. 5-8, particularly during LIVC operation, is further shown with reference to FIGS. 9-15. FIG. 9 illustrates the state of the actuator piston 120 and damper piston 134 during the opening ramp of a main event 172 and prior to the LIVC transition 178 (as shown in FIG. 15). During this time, the main event lift 172 will provide sufficient space between the actuator piston 120 and damper piston 134 such that hydraulic fluid will fill the actuator bore 132 thereby causing the actuator piston 120 extend to its maximum position (as dictated, in this example, by solid contact between the actuator piston spring retainer 126 and a shoulder 162 formed in the lash screw 122).

As further shown in FIG. 9, at the same time as the extension of the actuator piston 120, hydraulic fluid provided to the damper assembly 118 via the third hydraulic passage 133 and, for example, under control of a control valve and/or porting on the rocker shaft, will flow through the opening 135 to fill the space between the base 136 and damper piston 134, thereby causing the damper piston 134 to extend out of its bore, i.e., generally toward (i.e., upward in FIG. 9) the rocker arm 104 and actuator piston 120. As further shown in FIG. 9, checked passages 164, in addition to the opening 135, may be provided in the base 136 such that fluid may more quickly fill the space between the base 136 and damper piston 134 during valve opening.

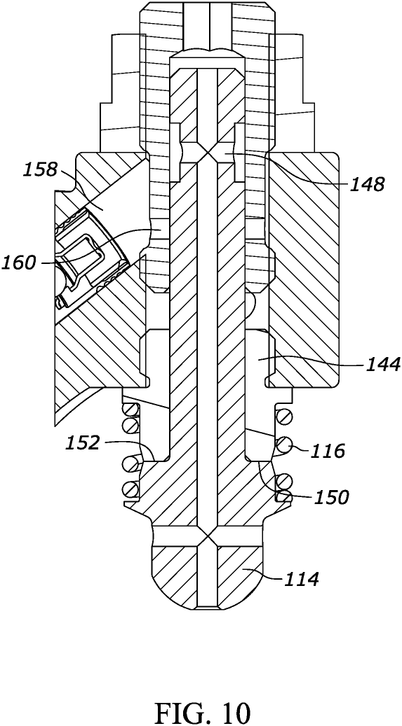

FIG. 10 illustrates operation of the reset assembly and plunger 114 during the same period depicted in FIG. 9, i.e., during valve opening and prior to the LIVC transition 178. During this time, the valve lift provided by the main event 172 will overcome any bias applied by the reset plunger spring 116 thereby causing the reset plunger 114 to translate upward until solid contact between the respective shoulders 150, 152 of the lower reset body 144 and the reset plunger 114, as shown. Notably, this upward translation of the reset plunger 114 will cause the reset port 148 to travel past the spill port 160, which will instead be sealed by an outer diameter of the reset plunger 114, as shown. Consequently, the hydraulic fluid within the actuator bore 132 is prevented from venting, and instead maintains the actuator piston 120 in its extended position.

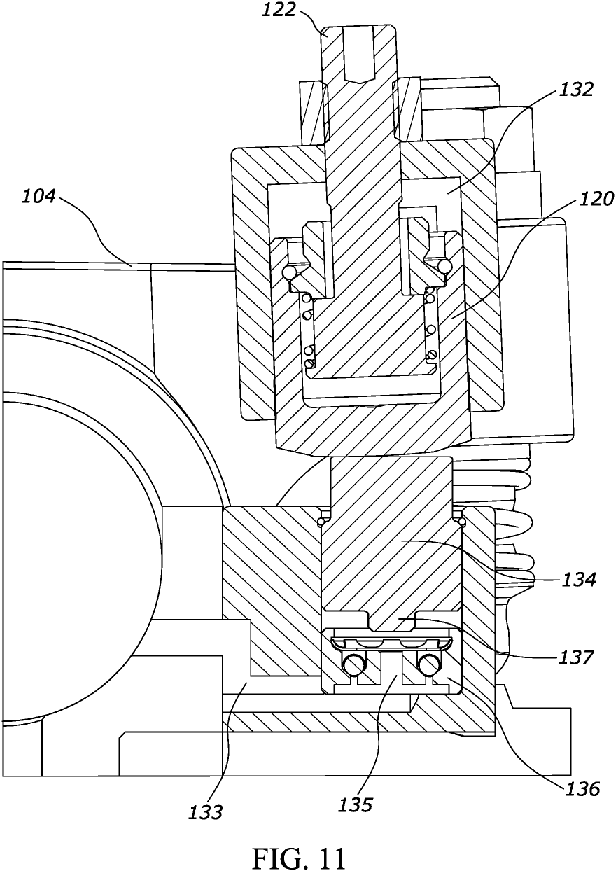

Referring now to FIG. 11, the state of the actuator piston 120 and damper piston 134 at that time where, during the closing ramp of the main event 172, the fully extended actuator piston 120 and damper piston 134 contact each other. With reference to the example illustrated in FIG. 15, this occurs at approximately 6 mm intake valve lift (assuming zero valve lash) or approximately 520 degrees crank angle. Further in this example, the stroke length of the damper piston 134 (i.e., the distance between the damper piston 134 and the base 136 when the damper piston 134 is fully extended) is assumed to be 2 mm.

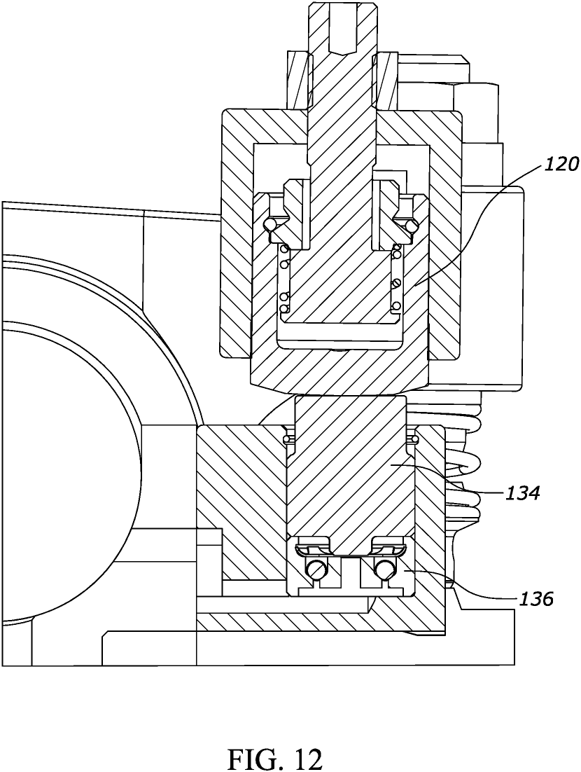

As the hydraulic damper piston 134 is pushed down by the fully extended actuator piston 120, hydraulic fluid is forced through the opening 135 in the hydraulic damper base 136. The curtain flow area between the hydraulic piston lower protrusion 137 and the opening 135 is progressively reduced as the damper piston 134 moves downward, throttling the flow of hydraulic fluid back into the third hydraulic passage 133 and providing the smooth transition 178 to the LIVC “back porch” dwell 180 (FIG. 15). The dwell 180, in turn, is provided when the damper piston 134 established solid contact with the base 136, thereby causing fully extended actuator piston 120 to hold the rocker arm (and, consequently, the intake valve(s)) in an open position. FIG. 12 illustrates this LIVC back porch lift condition or dwell 180, where the damper piston 134 is bottomed out on the base 136, while the actuator piston 120 remains in its fully extended position. As shown in the example of FIG. 15, the dwell 180 is maintained at approximately 3.5 mm intake valve lift for about 60-70 degrees of crank angle.

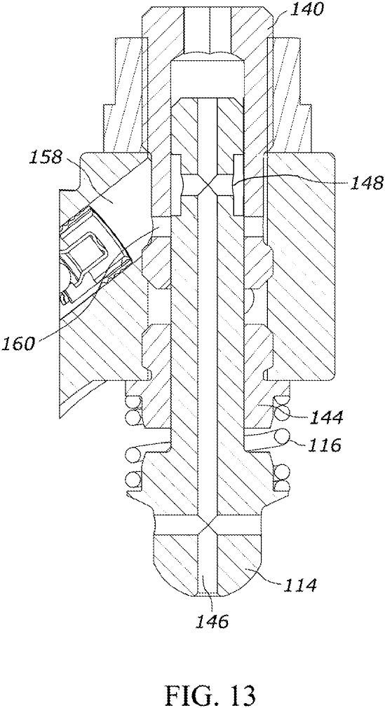

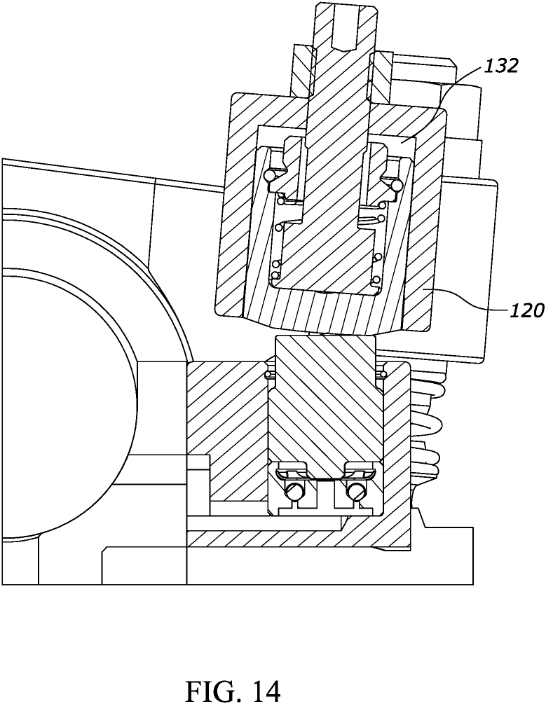

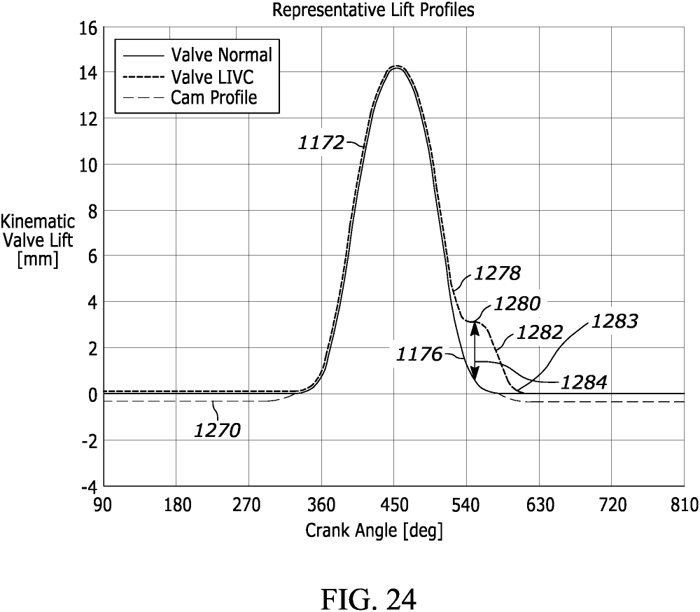

During the transition period 178 and LIVC dwell 180, a discrepancy or gap 184 (or 1284 in FIG. 24) develops between the lift maintained at the intake valve(s) and the cam profile 170. As shown in FIG. 13, this permits the reset plunger 114, under the bias applied by the reset plunger spring 116, to follow the cam profile 170 (FIG. 15) and thereby translate downward within the longitudinal channel formed in the upper reset body 140. This is illustrated in FIG. 13 by the gap created between the lower reset body 144 and the reset plunger 114. This process of the reset piston 114 following the cam profile 170 while the rocker arm 104 and intake valve(s) are maintained at the LIVC dwell 180 continues until such time that the reset port 148 begins to align with the spill port 160. As shown in FIG. 13, as soon as a slight overlap between the reset port 148 and the spill port 160 is provided, the pressurized fluid trapped in the actuator bore 132 (as well as the first hydraulic passage 130 and the second hydraulic passage 158) is able to vent to atmosphere through the flow path provided by the spill port 160, reset port 148 and venting passage 146. In turn, this permits the actuator piston 120 to retract back into the actuator bore 132 at a rate dictated by the rate of fluid venting through the spill port 160, reset port 148 and venting passage 146. As the actuator piston 120 retracts, the rocker arm 104 rotates toward the cam while the reset plunger 114 is simultaneously following the cam profile 170. In this case, the reset piston 114 will “dither” such that the reset port 148 and spill port 160 are maintained in this slight overlap positioning while the rocker arm 104 continues to rotate toward valve closing. In this manner, the valve lift closing event 182 is effectively commanded by the closing ramp 174 of the cam profile 170. This process of gradual valve closing continues until the actuator piston 120 is fully retracted into the actuator bore 132, as illustrated in FIG. 14.

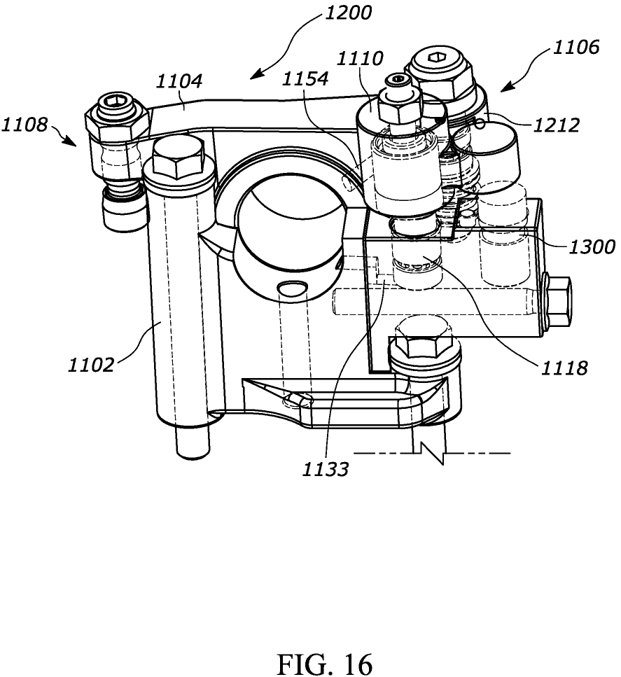

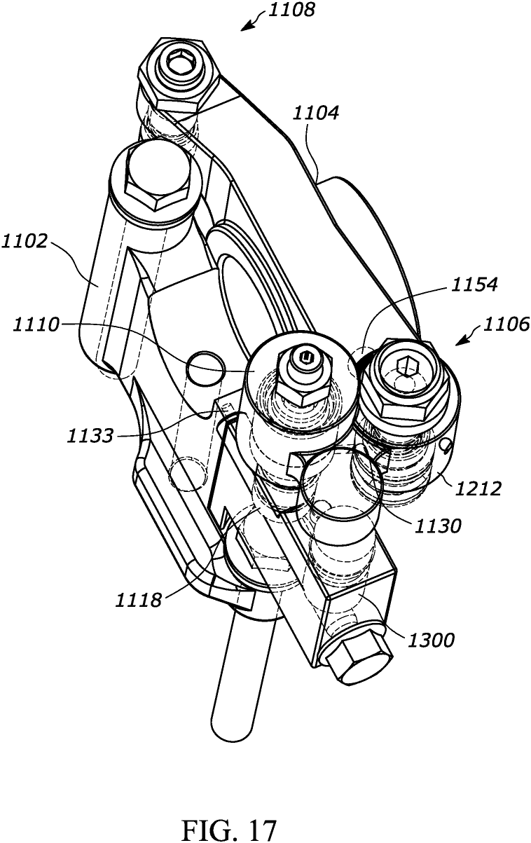

FIGS. 16 and 17 illustrate a second embodiment of a valve actuation system 1200. Like reference numerals depicted in FIGS. 5, 6, 16 and 17 refer to structures that are structured and operated in substantially the same manner. Thus, the rocker stop actuator assembly 1110 and damper assembly 1118 may be substantially similar to the rocker stop actuator assembly 1110 and 1118 in the first embodiments. In contrast, and as described below, the reset assembly 1212 may be structured and may operate somewhat differently as compared to the first embodiment illustrated in FIGS. 5 and 6. Additionally, a self-adjusting valve catch (SAVC) 1300 is provided in the second embodiment illustrated in FIGS. 16 and 17. The SAVC assembly 1300 may be substantially similar in construction and operation to the self-adjusting valve catches disclosed in U.S. Pat. No. 8,079,338, the entire disclosure and teachings of which are incorporated here by this reference.

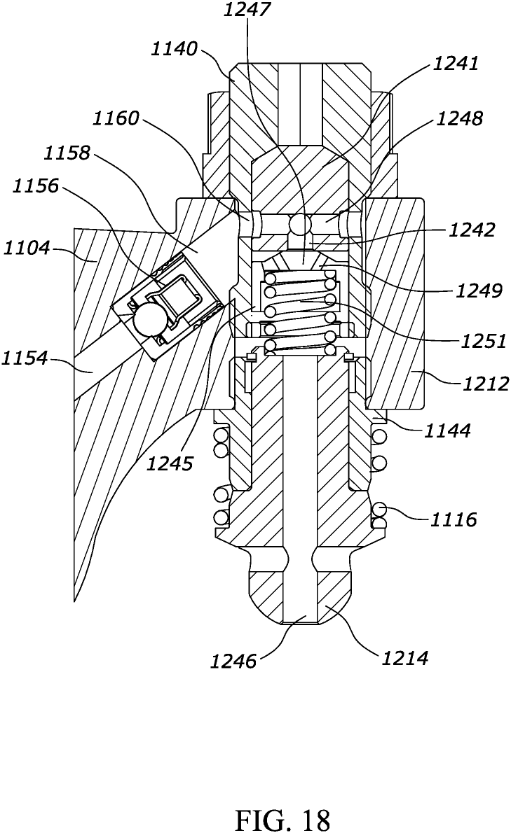

FIG. 18 illustrates further details, in cross section, of the reset assembly 1212 and rocker arm 1104 in accordance with the second embodiment. Once again, the rocker arm 1104 includes the fourth hydraulic passage 1154, check valve assembly 1156 and the second hydraulic passage 1158, whereas the rocker stop reset assembly 1112 assembly again comprises the upper reset body 1140 and lower reset body 1144. In this embodiment, however, the reset plunger 1214 only extends through a longitudinal channel formed in the lower reset body 1144, and a reset plug 1241 is provided having a reset port 1248 formed therein. In this case, the reset plug 1241 is fixedly maintained withing the longitudinal channel formed in the upper reset body 1140 such that reset port 1248 is continuously aligned with the spill port 1160 formed in the upper reset body 1140. The reset plug 1241 further comprises a central passage 1242 in fluid communication with the reset port 1248.

A reset piston 1245 is slidably disposed in the longitudinal channel formed in the upper reset body 1140. As shown, the reset piston 1245 has a central top face 1247 that aligns with the central passage 1242 of the reset plug 1241. The reset piston 1245 further comprises one or more channels 1249 extending from a periphery of the central top face 1247 and providing fluid communication with an interior region of the reset piston 1245. The reset piston 1245 is biased into contact with the reset plug 1241 by a reset piston spring 1251 disposed between the reset piston 1245 and the reset plunger 1214. As shown, the interior region of the reset piston 1245 is, in turn, in fluid communication with a venting passage 1246 formed in the reset plunger 1214. Provided that the biasing force applied by the reset piston spring 1251 is greater than any countervailing hydraulic force applied to the reset piston 1245 through the central passage 1242, the reset piston 1245 will remain abutted against the reset plug 1241, thereby preventing any fluid flow through central opening 1242, channels 1249 and venting passage 1246.

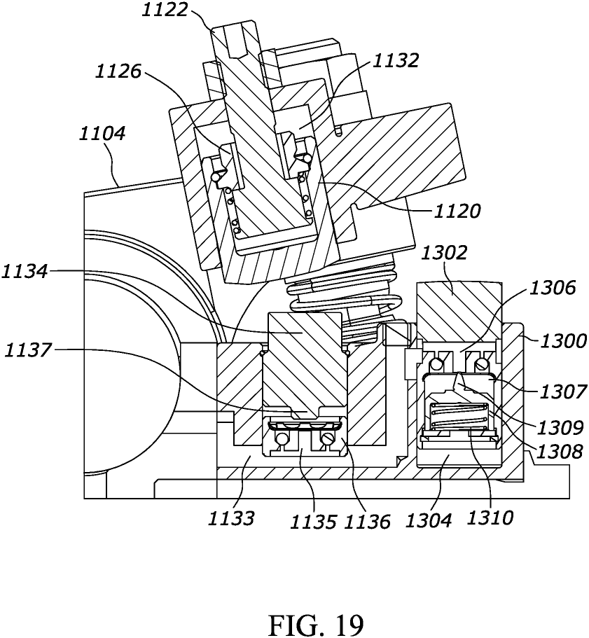

FIG. 24 illustrates an intake cam profile 1270 suitable for use in conjunction with the second embodiment illustrated in FIGS. 16-23. In particular, the cam profile 1170 illustrates the main intake event 1172 as described above. The cam profile 1270 further comprises a closing ramp 1176. Once again, during normal main event 1172 operation, hydraulic fluid is not provided to the actuator bore 1132 (FIG. 19), thereby preventing extension of the actuator piston 1120. Consequently, the actuator piston 1120 will not engage the damper piston 134 such that the rocker arm is permitted close 1176 in a normal manner, i.e., without LIVC operation. However, during LIVC operation, hydraulic fluid is once again provided to (and trapped within) the actuator bore 1132 such that the actuator piston 1120 will be maintained in its extended position, thereby maintaining the engine valve in an opened position 1280 to provide the desired LIVC operation. Interaction of the actuator piston 1120 and the damper piston 1134 again provides a smooth transition 1278 between the main event lift 1172 and LIVC dwell 1280. As described in further detail below, subsequent operation of the reset assembly 1212 will cause the actuator piston 1120 to collapse, thereby providing a closing event 1282 and a valve seating profile 1283 controlled by the SAVC 1300, as described in further detail below.

Referring again to FIG. 18, the state of the reset plunger 1214 and reset piston 1245 are shown during the opening ramp of a main event 1172 and prior to the LIVC transition 1278 (as shown in FIG. 24). That is, despite the presence of fluid in the second hydraulic passage 1158 and reset port 1248, the bias of the reset piston spring 1251 is sufficient to maintain the reset piston 245 in sealing engagement with the central passage 1242, which in turn permits the actuator piston 1120 to extend out of the actuator bore 1132, as described previously.

As further shown in FIG. 19, at the same time as the extension of the actuator piston 1120, hydraulic fluid provided to the damper assembly 1118 via the third hydraulic passage 1133 will flow through the opening 1135 and past protrusion 1137 to fill the space between the base 1136 and damper piston 1134, thereby extending the damper piston 1134 as described above. As further shown, the third hydraulic passage 1133 additionally extends, in this embodiment, to an SAVC assembly 1300 that operates essentially identically to the damper assembly 1118, albeit in this embodiment, in an inverted manner. That is, as shown, the SAVC assembly 1300 comprises a slidable SAVC base 1302 disposed in an SAVC bore 304 that is in fluid communication with the third hydraulic passage 133. An internal chamber 1307 is formed in the SAVC base 1302 and an opening 1306 (along with optional checked passages as shown) provides fluid communication between the third hydraulic passage 1133 and the internal chamber 1307. An SAVC plunger 1308 is disposed in the internal chamber and is biased upward toward the opening 1306 by an SAVC plunger spring 1310. The SAVC plunger 1308 further comprises a protrusion 1309 that aligns with the opening 1306. As shown, hydraulic pressure provided by the third hydraulic passage 1133 causes fluid to enter the internal chamber 1307, which fluid is sufficiently pressurized to overcome any biasing force applied by the SAVC plunger spring 1310, thereby causing the protrusion 1309 to disengage from the opening 1306. Additionally, as described in U.S. Pat. No. 8,079,338, leakage of the pressurized hydraulic fluid past the SAVC plunger 1308 results in a substantially consistent volume of fluid to fill into the space formed by the interior region of the SAVC plunger 1308 and the walls of the SAVC bore 1304.

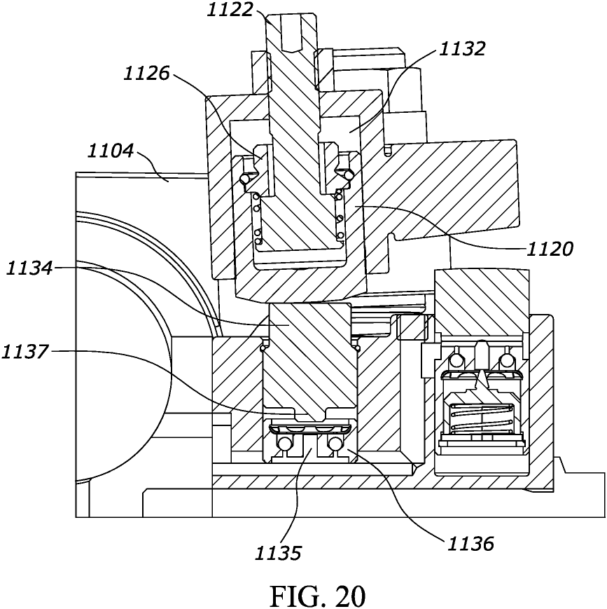

Referring now to FIG. 20, the state of the actuator piston 1120 and damper piston 1134 at that time where, during the closing ramp of the main event 1172, the fully extended actuator piston 1120 and damper piston 1134 contact each other. With reference to the example illustrated in FIG. 24, this occurs once again at approximately 6 mm intake valve lift (assuming zero valve lash) or approximately 1520 degrees crank angle. Further in this example, the stroke length of the damper piston 1134 is again assumed to be 2 mm.

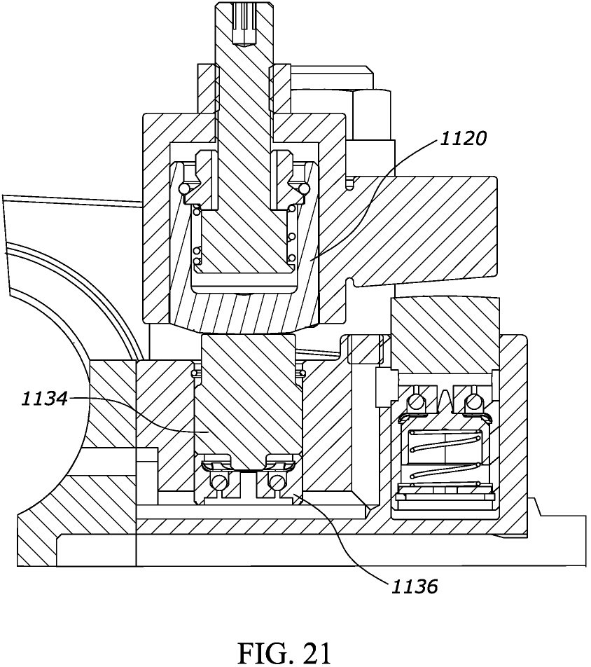

As described above, continued interaction between the fully extended actuator piston 1120 and damper piston 1134 provides the smooth transition 1278 to the LIVC “back porch” dwell 1280. Once again, the dwell 1280 is provided when the damper piston 1134 bottoms out with the base 1136, thereby causing fully extended actuator piston 1120 to hold the rocker arm (and, consequently, the intake valve(s)) in an open position. FIG. 21 illustrates this LIVC back porch lift condition or dwell 1280, where the damper piston 1134 is bottomed out on the base 1136, while the actuator piston 1120 remains in its fully extended position. As shown in the example of FIG. 24, the dwell 1180 is maintained at approximately 3.5 mm intake valve lift for about 20-30 degrees of crank angle.

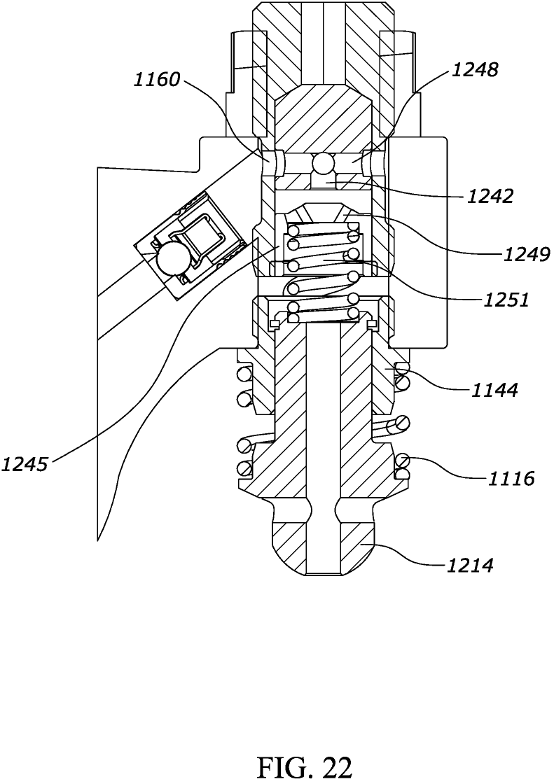

Once again, during the transition period 1278 and LIVC dwell 1280, a discrepancy or gap 1276 develops between the lift maintained at the intake valve(s) and the cam profile 270. As shown in FIG. 22, this permits the reset plunger 1214, under the bias applied by the reset plunger spring 1116, to follow the cam profile 1170, particularly the closing ramp 1176, thereby translating downward within the longitudinal channel formed in the lower reset body 1144. This is illustrated in FIG. 22 by the gap created between the lower reset body 1144 and the reset plunger 1214. This process of the reset piston 1214 following the cam profile 1270 while the rocker arm 1104 and intake valve(s) are maintained at the LIVC dwell 1280 continues until such time that the spring force applied by the reset piston spring 1251 drops below the hydraulic pressure force being applied to the reset piston 1245, thereby causing the reset piston 1245 to translate downward. This, in turn, opens a fluid path though the spill port 1160, reset port 1248 and channels 1249 and into the venting passage 1246. In this case, unlike the “dithering” embodiment described above, the spill port 1160 stays substantially open because the hydraulic pressure forces the reset piston 1245 increases greatly due to the large increase in pressure area and the fact that most of the pressure drop occurs across the channels 1249 formed in the reset piston 1245. As a result, the actuator piston 1120 will rather quickly retract into the actuator bore 1132, which in turn would likewise cause the rocker arm 1104 and intake valve(s) to close equally quickly, which could lead undesirable impacts during valve seating.

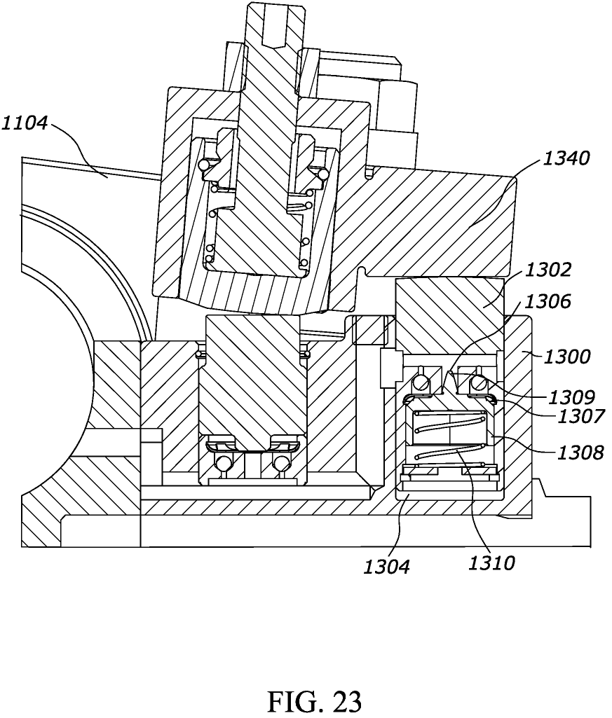

To this end, the SAVC assembly 1300 operates to engage the rocker arm 1104 and provide a gradual valve seating event 1283. In particular, as the rocker arm 1104 rotates toward the motion source, an extension 1340 of the rocker arm engages the SAVC base 1302, thereby forcing it into the SAVC bore 1304 and compressing the hydraulic fluid within the internal chamber 1307. At the same time, however, the volume of fluid trapped behind the SAVC plunger 308 prevents the SAVC plunger 1308 from retreating further into the SAVC bore 1304. Consequently, as the SAVC base 1302 is displaced downward, the relative lack of movement of the SAVC plunger 1308 causes hydraulic fluid to be expelled from the decreasing-volume of the internal chamber 1307 through the opening 1306 and back into the third hydraulic passage 1133. As the SAVC base 1302 approaches the SAVC plunger 1308, the continuously reduced flow area between the protrusion 1309 and opening 1306 increases resistance to the escaping hydraulic fluid, thereby smoothly slowing further descent of the SAVC base 1302. This process continues until the protrusion 1309 fully engages and seals the opening 1306 such that further escape of hydraulic fluid, and further descent of the SAVC base 1302 is prevented, as shown in FIG. 23. As further shown in FIG. 23, the process of gradual valve closing also continues until the actuator piston 1120 is fully retracted into the actuator bore 1132.

While particular embodiments have been shown and described, those skilled in the art will appreciate that changes and modifications may be made without departing from the instant teachings. It is therefore contemplated that any and all modifications, variations or equivalents of the above-described teachings fall within the scope of the basic underlying principles disclosed above.

For example, while the rocker motion stop actuator piston in the described embodiments is disposed in the rocker arm, it will be recognized that other arrangements are within the scope of the instant disclosure. For example, the rocker motion stop actuator piston may be located in a stationary housing (rocker shaft pedestal) and be arranged to contact the cam side of the rocker arm. Alternatively, the rocker motion stop may be arranged and adapted to be disposed in the valve side of the rocker arm and be disposed therein or in a stationary housing.

What is claimed is:

1. A valve actuation system for actuating at least one engine valve, the valve actuation system comprising:
a rocker for conveying motion to the at least one valve;
a motion source arranged to impart motion to the rocker, the motion source defining a main event peak lift for the at least one engine valve;
a rocker stop assembly configured to operate in an activated mode, in which the rocker stop assembly maintains the rocker in a position corresponding to valve lift, and a deactivated mode, in which the rocker stop assembly allows the rocker to move to a position corresponding to a fully closed valve position; and
a rocker stop reset assembly for resetting the rocker stop assembly to the deactivated mode subsequent to the main event peak lift to thereby achieve late valve closing.

2. The valve actuation system of claim 1, wherein the rocker stop assembly is disposed in the rocker.

3. The valve actuation system of claim 1, wherein the rocker stop assembly is disposed in the cam side of the rocker.

4. The valve actuation system of claim 1, wherein rocker stop assembly comprises a hydraulically actuated piston.

5. The valve actuation system of claim 1, wherein the rocker stop reset assembly is adapted to reset the rocker stop assembly to the deactivated mode at a predetermined rotational angle of an engine crankshaft or cam.

6. The valve actuation system of claim 1, wherein the rocker stop reset assembly comprises a plunger adapted to extend to take up lash between the motion source and rocker, wherein the plunger is further adapted to reset the rocker stop assembly to the deactivated mode when the plunger extends to a reset position.

7. The valve actuation system of claim 1, wherein the rocker stop reset assembly is adapted to retain the rocker stop assembly in the activated mode during a portion of a closing profile of the motion source.

8. The valve actuation system of claim 1, wherein the motion source is a single cam lobe.

9. The valve actuation system of claim 1, further comprising a damper assembly arranged to interact with the rocker stop assembly and adapted to provide a smooth transition of the rocker and valve motion to a late intake valve closing dwell.

10. The valve actuation system of claim 9, wherein the damper assembly is disposed in a fixed housing relative to the rocker.

11. The valve actuation system of claim 1, further comprising a valve catch assembly arranged to interact with the rocker and adapted to control the seating velocity of the at least one valve.

12. The valve actuation system of claim 11, wherein the valve catch assembly is disposed in a fixed housing relative to the rocker.

13. The valve actuation system of claim 11, wherein the valve catch assembly is arranged to interact with a projection on the cam side of the rocker.

14. The valve actuation system of claim 1, wherein the rocker stop assembly and rocker stop reset assembly are disposed on the cam side of the rocker.

15. The valve actuation system of claim 1, wherein the rocker stop assembly and rocker stop reset assembly are linked through at least one hydraulic passage.

16. The valve actuation system of claim 1, wherein the motion source comprises a sub-base circle cam profile with a closing ramp, where the rocker stop reset mechanism is adapted to permit the rocker stop assembly to collapse at a rate such that the rocker arm follows the sub-bas circle closing ramp.

17. The valve actuation system of claim 1, wherein the rocker stop reset mechanism is adapted to reset the rocker stop assembly to the deactivated mode based on motion source lift and to collapse at a rate independent of the motion source.

18. The valve actuation system of claim 17, wherein the rocker stop reset mechanism comprises a spring-biased reset piston adapted to retain hydraulic fluid in the rocker stop assembly in the activated mode and to vent hydraulic fluid from the rocker stop assembly to ambient in the deactivated mode, wherein the reset piston is adapted to stay open during rocker stop assembly collapse.
